(19) United States
(12) Patent Application Publication
(10) Pub. No.: US 2003/0195952 A1
(43) Pub. Date: Oct. 16, 2003

(54) Digital transmitter device configuration

(76) Inventors: Steven G. Henry, Ft. Collins, CO (US); Arti Shukla, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/123,497

(22) Filed: Apr. 15, 2002

(51) Int. Cl. G06F 15/177

(52) U.S. Cl. 709/220; 709/245

(57) ABSTRACT

Message data is sent from an unconfigured digital transmitter device requesting configuration data, where the unconfigured digital transmitter device receives and interprets the requested configuration information to effect a configuration thereof.

### FIELD OF THE INVENTION

The present invention relates generally to configuration of peripheral devices, and more particularly to configuration of a digital transmitter device.

### BACKGROUND OF THE INVENTION

Many peripherals to computer networks include a scanner component. One example of such a peripheral is an “All-in-one”, also known as a multifunction peripheral (MFP) in that it has the capability to perform the multiple functions of scanning hardcopy documents, copying, and printing. Another example is a digital network copier that scans in documents from an automatic document feeder, does high volume copying, and has the capabilities of binding, collating, folding, stacking, stapling, stitching, edge-trimming, paginating, and printing on substrates of varied composition. Each of these peripherals, when in communication with an interconnecting network, can also be described as being a digital transmitter. A digital transmitter is an appliance that has a keyboard, a display, and a scanner. The digital transmitter need not have a printer. A digital camera is a type of digital transmitter, but in comparison to the foregoing, it is not as useful for handling documents and typically lacks the resolution and ability to rapidly and repetitively transfer information after scanning to a repository.

In an exemplary digital sending operation, a hardcopy of a document can be presented to the scanner portion of a digital transmitter. After scanning, the digital transmitter transforms the scanned image into a digital representation of the document that is then saved in a data format, such as in a bit map data format or in a Portable Document Format (PDF). Electronic messaging can be used to send an electronic mail (e-mail) from the digital transmitter device with an attachment of the document in the data formats. The e-mail can be sent to recipients over the interconnecting network, where the recipients have an e-mail address that a user manually enters at the digital transmitter device or that user specifies using a defined list of recipient e-mail addresses.

In order to use a digital transmitter device over an interconnecting network, the digital transmitter device must be configured for use on the interconnecting network. There are several methods of providing configuration information to the digital transmitter. One method is to use a web browser to manually make changes to the configuration of a digital transmitter device using an embedded-web server in the digital transmitter device. Another configuration method is known as Active Directory, which is a service that is set up to configure the digital transmitter device with information as to other resources that are in communication with the interconnecting network. A still further configuration method is the initiation of a software program by an administrator of an interconnecting network, where the software searches the interconnecting network to discover digital transmitter devices on the interconnecting network, and then presents the administrator with a variety preset configuration options to configure the digital transmitter device. An example of the later method is the WebJetAdmin™ software available from the Hewlett Packard Company. In each of these configuration methods, a manually established connection is required to the digital transmitter device, or the administrator is required to manually input the configuration into a directory. When multiple digital transmitter devices on an interconnecting network must be configured, the manual configuration task can be burdensome for an administrator of the interconnecting network. It would be beneficial to minimize the tasks required to configure digital transmitter devices in communication with an interconnecting network. Consequently, there is a need for improved methods and apparatuses that can provide such a capability.

### SUMMARY OF THE INVENTION

Message data is sent from an unconfigured digital transmitter device requesting configuration data. The requested configuration information with the unconfigured digital transmitter device is interpreted to configure the unconfigured digital transmitter device.

These and other features of the present invention will become more fully apparent from the following description and appended claims, or may be learned by the practice of the invention as set forth hereinafter.

### DESCRIPTION OF THE DRAWINGS

A more complete understanding of the various methods and apparatuses of the present invention may be had by reference to the following detailed description when taken in conjunction with the accompanying drawings wherein the same reference numbers are used throughout the drawings to reference like components and features, and wherein:

FIG. 1 is a block diagram depicting a computing and communication environment having a digital transmitter device in a system environment suitable for providing local access to the digital transmitter device.

FIG. 2 illustrates various digital transmitter devices that provide local access for input thereto.

FIG. 3 is a block diagram illustrating a digital transmitter device in communication with a host computer in a system such as that shown in FIG. 1.

FIG. 4 is a flow diagram depicting a method for use in a computing and communication environment having a digital transmitter device in a system as in FIG. 1, for example, in accordance with certain exemplary implementations of the present invention.

### DETAILED DESCRIPTION

The methods and apparatuses described herein relate to the configuration of a digital transmitter device, and to the driving of the configuration with technologies used to implement web pages. To obtain configuration information a user keys in the name and network location address of a menu page in which the configuration information is contained. The digital transmitter device then retrieves the configuration information that is stored on a network resource at the user specified address. The network resource can be a server that is in communication with an interconnected network with which the digital transmitter device is also in communication. The retrieved configuration information can be stored on a server module on the digital transmitter device. Script code executing on a processor associated with the digital transmitter device alters internal device settings of the digital transmitter device by interpreting the configuration information in the retrieved menu page so as to configure the digital transmitter device.

Preferably, configuration information for one or more digital transmitter devices is stored in a menu page that is formatted in a markup language document, such as a Hyper Text Markup Language (HTML) document, or more preferably an Extensible Markup Language (XML) document. As such, a browser application executing on a host computer can be used to control the configuration information for the digital transmitter device. The control of the configuration information makes the digital transmitter device easily reconfigurable to accommodate alternative configurations. A network administrator can maintain the configuration information stored on the server for one or several digital transmitter devices using a Web browser to edit and update the menu pages.

In another embodiment of the invention, several slave digital transmitter devices are in a communicating network with a master digital transmitter device. A user can use a user interface at the master digital transmitter device to set up all or a portion of the configuration information for the master digital transmitter device. Any remaining configuration information that is not input at the user interface at the master digital transmitter device can be later input using a Web browser at a personal computer or other computing device to edit and update the menu pages by which the configuration information is controlled. After the master digital transmitter device has received the configuration control information, the slave digital transmitter devices can communicate with the master digital transmitter device to retrieve their respective configurations. By way of example, each slave digital transmitter device can contain execute an application program on a processor that operates a timer. When a time out value is counted out by the timer, the slave digital transmitter device communicates with the master digital transmitter device to retrieve their respective configurations. Accordingly, changes to configuration information can be controlled at, and distributed from, the master digital transmitter device.

Exemplary System for Configuration of a Digital Transmitter Device

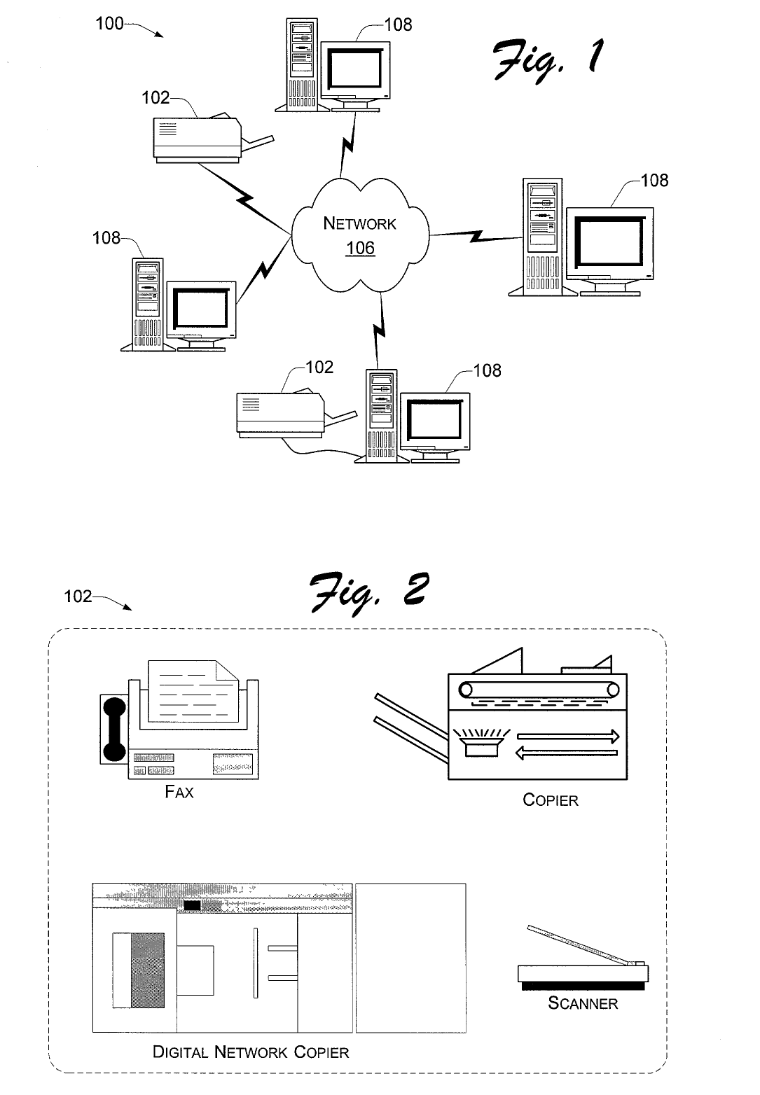

FIG. 1 illustrates an example of a system environment 100 suitable for implementing a process driven by web page technologies that controls the configuration of one or more digital transmitter devices 102, including a master digital transmitter device in communication through an interconnecting network 106 with one or more slave digital transmitter devices. The system environment 100 contemplates local access to an input device, such as a touch sensitive menu screen, on a digital transmitter device 102. A user accesses the input device for the purpose of entering a name and location of a menu page containing configuration information for the digital transmitter device 102.

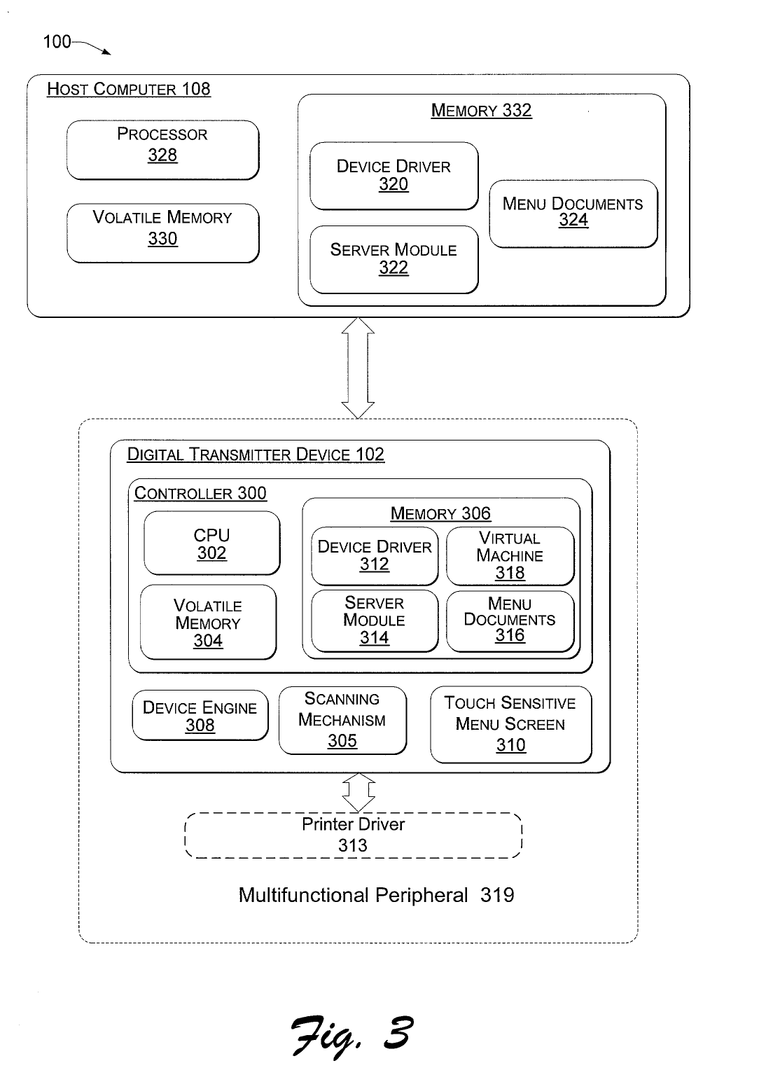

Digital transmitter devices 102 generally include peripheral devices and stand-alone devices. Peripheral devices include devices such as printers, scanners, copiers, and fax machines, or multifunction peripheral (MFP) devices that combine two or more peripheral devices into a single device. Stand-alone devices include certain peripheral devices that often function while uncoupled or isolated from other devices. Digital transmitter devices 102 therefore include devices such as copiers, scanners and fax machines like those shown in FIG. 2.

Digital transmitter devices 102 are generally distinguishable from devices such as laptop PCs (personal computers) and pocket PCs by their limited purpose and limited user interface or input/output capabilities. For example, a typical user interface for a digital transmitter device 102 includes a front menu panel with limited screen space and a limited number of buttons. In addition, a digital transmitter device 102 is typically oriented toward performing one general task such as scanning. By contrast, devices such as laptop and pocket PCs often provide multiple and varied means of input/output such as a full screen display, a QWERTY keyboard, a trackball mouse, speakers, microphones, PCMCIA (Personal Computer Memory Card International Association) slots, portable media drives and the like. These devices are capable of performing multiple functions through executing various software applications such as word processing applications, spreadsheet applications, financial applications, network browsers and network messaging applications.

Exemplary Embodiment of an Apparatus for Implementing Configuration of the Same

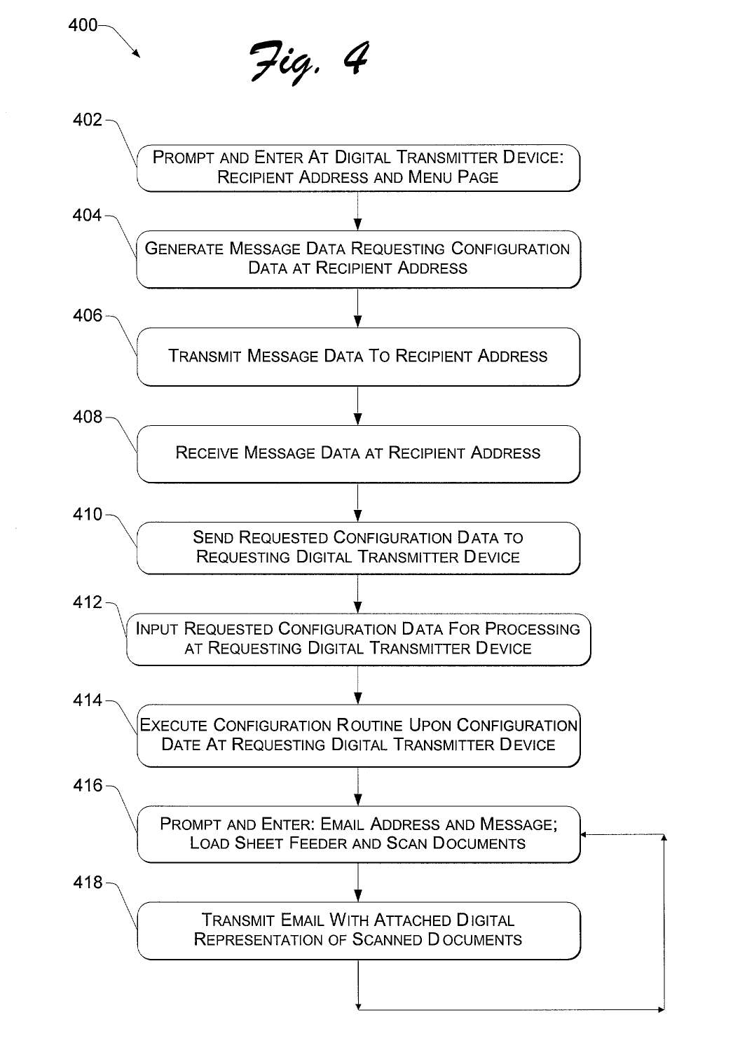

FIG. 3 illustrates an embodiment of the system 100 of FIG. 1 in greater detail. In accordance with still other aspects of the present invention, digital transmitter device 102 may be included within a multiple function peripheral (MFP) device 319. As its name implies, MFP device 319 is configured to provide multiple functions. In this example, the functions provided by MFP device 319 include those provided by digital transmitter device 102 and a printer device 313. Consequently, the user of digital transmitter device 102 may also print out a hardcopy of any applicable portions of the message data.

The system 100 of FIG. 3 includes digital transmitter device(s) 102 as peripheral devices coupled through an interconnecting network 106. Digital transmitter 102 includes a CPU 302, which is operatively coupled to a memory 306, a user interface such as a touch sensitive screen 310, a scanning mechanism 305, and at least one communication port for interfacing with the interconnecting network 106. When included in a multifunctional peripheral (MFP) device 319, CPU 302 would also be operatively coupled to a printer device 313, for example. CPU 302 is representative of any hardware, firmware and/or software that is configured to perform certain functions associated with the operation of digital transmitter device 102 and, if applicable, MFP 319. Hence, as those skilled in the art will recognize, CPU 302 may include dedicated logic and/or one or more processors configured in accord with software instructions, for example.

Memory 306 is representative of any type of data storage mechanism that can be accessed by at least CPU 302. Memory 306 may therefore include, for example, some form of random access memory (RAM); some form of read only memory (ROM), and/or other like solid-state data storage mechanism. Memory 306 may include a magnetic and/or optical data storage mechanism. Scanning mechanism 305 is representative of any optical scanner technology that may be employed to produce scanned object data upon scanning an object. Such scanning technologies are well known. The resulting scanned object data is provided to CPU 302 and/or stored in memory 306.

Interconnecting network 106 is representative of one or more communication links, either wired or wireless, that are capable of carrying data between digital transmitter 102 and other network resources in communication with interconnecting network 106. In certain exemplary implementations, interconnecting network 106 includes a local area network (LAN), a wide area network (WAN), an intranet, the Internet, or other similar network. Digital transmitter device(s) 102 are also typically coupled to host computer(s) 108 either through a direct or network connection.

In general, the host computer 108 outputs host data to a digital transmitter device 102 in a driver format suitable for the digital transmitter device 102, such as PCL or postscript for printer device 313. Printer device 313 converts the host data and outputs it onto an appropriate print media, such as paper, transparencies or glossy photo paper.

The peripheral or digital transmitter device 102 has a controller 300 that processes the host computer 108 data. The controller 300 typically includes data processing unit or CPU 302, a volatile memory 304 (i.e., RAM), and a non-volatile memory 306 (e.g., ROM, Flash). Digital transmitter device 102 also includes a device engine 308 and an input device. Preferably, the input device will be locally accessible at digital transmitter device 102. By way of example, the input device can be a touch sensitive menu screen. The touch sensitive menu screen acts as a local user interface for digital transmitter device 102 by displaying menu pages and accepting user input based on selectable menu items displayed on the menu pages. The Touch sensitive menu screen can be used to display a menu page that asks for and receives input needed to configure digital transmitter device 102. Preferably, the input will include the network address at which configuration information is stored for digital transmitter device 102, as well as the name of a resource, such as a menu page, that contains the configuration information at the network storage address.

A device controller 300 processes host data and manage device functions by controlling a device engine 308 and responding to input from a touch sensitive menu screen 310. Controller 300 includes a device driver software 312 stored in a memory 306 and executed on a processor, such as a CPU(s) 302. Memory 306 also includes a server module 314 configured to serve menu documents 316 to the touch sensitive menu screen 310. The server module 314 is a local server in the sense that it is present within the same digital transmitter device 102 to which it serves menu documents 316. Menu documents 316 are interpreted by the server module 314 and are configured to display textual and graphical information as menu pages on the touch sensitive menu screen 310.

Within system 100 of FIG. 1, a host computer(s) 108 executes a browser application. Host computer(s) 108 can also act as a remote server that serves menu pages for storage in markup language (menu) documents 316 at digital transmitter device 102. The browser application executing on the host computer(s) 108 can be used by a network administrator to create and update configuration information for one or more digital transmitter devices 102 that are also in communication with interconnecting network 106. The browser application is useful for creating and editing configuration information. The configuration information will preferably be formatted as markup language documents using markup languages such as HTML (hypertext markup language) and XML (extensible markup language). By way of example, the administrator of interconnecting network 106 can use the browser application executing on host computer(s) 108 to move configuration information from one HTML document at one uniform resource locator (URL) that is designated for use by a first digital transmitter device to another HTML document at another URL that is designated for use by a second digital transmitter device. In this way, the first and second digital transmitter devices can be configured identically when the menu page is received and interpreted by CPU 302 on the respective digital transmitter device.

Graphical keys or buttons presented on menu pages that are displayed by the touch sensitive menu screen 310 offer selectable menu items that are described by accompanying textual information. Menu documents 316 driving the menu pages include embedded script code associated with graphical keys. Selecting a menu item by pressing a graphical key on the touch sensitive menu screen 310 triggers an event which causes a “virtual machine” 318 to interpret and execute the script code associated with the selected graphical key. The virtual machine 318 is a software module stored in memory 306 that executes on CPU(s) 302 to interpret and execute script code. The script code is preferably written in JavaScript code that is interpreted and executed on a Java Virtual Machine (JVM) 318. However, the script code can also be written in other script code languages such as VBScript or Perl.

The script code associated with selectable menu items (i.e., graphical keys or buttons) is configured to perform the task of receiving a name and a location of configuration information for digital transmitter 102. Digital transmitter device 102 can be in an unconfigured state at the time when a user inputs the name and the location of the configuration information. When so received, the script code associated with selectable menu items will retrieve the configuration information from a server or other storage location, such as host computer(s) 108 that is also in communication with interconnecting network 106.

A server module 322 on host computer 108 acts as a remote server to the digital transmitter device 102, serving menu documents 324 that contain configuration information for digital transmitter device 102. When the configuration information is retrieved from the host computer(s) 108, the script code executing on CPU 302 of digital transmitter device 102 can change the status of digital transmitter device 102 from an unconfigured state to a configured state. Alternatively, execution of the script code can be used to change the status of digital transmitter device 102 from one configured state to a different configured state that is consistent with the interpretation of the markup language in the retrieved menu page that contains the configuration information. As such, modifications to digital transmitter device configurations can be readily preformed as an administrative task by the use of a browser application to create and edit various states of configuration for various digital transmitter devices using markup language documents in the form of menu pages.

The host computer 108 includes a processor 328, a volatile memory 330 (i.e., RAM), and a non-volatile memory 332 (e.g., ROM, hard disk, floppy disk, CD-ROM, etc.). The host computer 108 may be implemented, for example, as a general-purpose computer, such as a desktop personal computer, a laptop, a server, and the like. The host computer 108 may implement one or more software-based device drivers 320 that are stored in non-volatile memory 332 and executed on the processor 328 to configure data into an appropriate format (e.g., PCL, postscript, etc.) and output the formatted data to the digital transmitter device 102.

Exemplary Embodiment of a Method For Configuring a Digital Transmitter Device

With this in mind, CPU 302 is configured to perform the operations described above. By way of further example, a flow diagram is depicted in FIG. 4 to illustrate certain exemplary functions that can be performed using CPU 302 and the other resources in digital transmitter device 102. Here, a process 400 is provided.

In step 402, digital transmitter device 102 is in an unconfigured state. As such, digital transmitter device 102 does not store the digital address or identity of an email server, a name directory, or other network resources on interconnecting network 106. A user then provides a recipient address data to digital transmitter device 102 by making input at touch sensitive screen 310. The recipient address data includes a name of a configuration menu page as well as the location of the menu page on interconnecting network 106. In step 404, message data is generated by using the digital transmitter device 102. In step 406, the message data is addressed according to the recipient address data received as input from the user at touch sensitive screen 310. Then, the message data is forwarded over interconnecting network 106 to the storage location designated in the recipient address data. In step 408, the storage location, such as host computer(s) 108, retrieves the specified menu page from menu documents 324.

In step 410, the retrieved menu page is then transmitted over interconnecting network 106 back to digital transmitter device 102 for storage in menu documents 316. In step 412, server module 314 serves the requested menu page stored in menu documents 316 to CPU 302 for execution of script code. In step 414, the script code being executed by CPU 302 effects the configuration of digital transmitter device 302. The script code will preferably be executed in conjunction with an interpretation of the markup language in the requested menu page stored. Note that in certain implementations, the retrieved menu page can be directly interpreted by script code executing on CPU 302 without any prior storage in menu documents 316 or use of server module 314 in digital transmitter device 102.

In step 416, using touch sensitive menu screen 310, a user can be prompted to enter user input data, such as, e.g., a recipient(s) e-mail address information, the subject of the e-mail, the text or body of the e-mail, etc. The user then inputs at touch sensitive menu screen 310 recipient address data to which facsimiles of a set of documents are to be sent. The recipient address data will preferably be an email address. The user then places the set of documents into a sheet feeder device associated with digital transmitter device 102. The sheet feeder device then physically serves each sheet in the set of documents to scanning mechanism 305. CPU 302 then generates a bit map or other output that is a digital representation of the scanned documents. For example, the scanned object data may be included in the e-mail message data as an attached file. The scanned object data may include Portable Document Format (PDF) formatted data, tagged image file format (TIFF) formatted data, Joint Photographic Experts Group (JPEG) formatted data, bit-map formatted data, optical character recognition (OCR) related data, American Standard Code for Information Interchange (ASCII) formatted data, and/or other forms of encoded data, including, e.g., encrypted data, etc.

In step 418, a message data is addressed according to the recipient address data received from the input by the user. The message data may, for example, include electronic mail (i.e., e-mail) message data from the user of the digital transmitter device to the user(s) of the remote device(s). Here, an e-mail message would include the scanned object data in some manner.

In accordance with still other aspects of the present invention, CPU 302 may be configured to maintain at least one recipient address data list within memory 306. The recipient address data list may include a plurality of recipient addresses associated with a plurality of potential message data recipients. CPU 302 may also be configured to selectively modify the recipient address data list based on the received recipient address data from digital transmitter device 102.

Thus, although some preferred embodiments of the various methods and apparatuses of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the spirit of the invention as set forth and defined by the following claims.

What is claimed is:

1. A method of configuring an unconfigured digital transmitter device that is capable of sending message data, the method comprising the steps of:
receiving input at the unconfigured digital transmitter device of a network address at which at configuration information for the unconfigured digital transmitter device is located;
sending message data from the unconfigured digital transmitter device to the network address, the message data containing a request for the configuration information;
receiving at the unconfigured digital transmitter device the configuration information from the network address; and
processing the configuration information at the unconfigured digital transmitter device to configure digital transmitter device.

2. The method as defined in claim 1, further comprising:
receiving at the configured digital transmitter device an email address for sending message data;
optically scanning at the configured digital transmitter device at least one object to form corresponding scanned object data;
forming in said message data said scanned object data; and
addressing said message data using said email address data.

3. The method as defined in claim 1, wherein the processing the configuration information at the unconfigured digital transmitter device to configure digital transmitter device comprises interpreting the configuration information contained in at least one menu page.

4. The method as defined in claim 3, wherein the menu page is a markup language document that is formatted using a markup language selected from the group consisting of Hyper Text Markup Language (HTML) and Extensible Markup Language (XML).

5. A method of configuring a digital transmitter device that is capable of sending message data, the method comprising the steps:
receiving message data at a network resource located at a network address, the message data being received from an unconfigured digital transmitter device and including the network address and a request for configuration information for the unconfigured digital transmitter device; and
transmitting from the network address a markup language document to the unconfigured digital transmitter device, wherein the markup language document:
contains predetermined configuration information sufficient to configure the unconfigured digital transmitter device; and
is formatted in a markup language selected from the group consisting of Hyper Text Markup Language (HTML) and Extensible Markup Language (XML).

6. The method as defined in claim 5, further comprising, prior to the transmitting a markup language document:
editing the markup language document using a browser application to create the predetermined configuration information sufficient to configure the unconfigured digital transmitter device.

7. A method of configuring a digital transmitter device that is capable of sending message data, the method comprising the steps:
accepting user input through a user interface of said digital transmitter device, said user input including user provided data comprising configuration recipient address data and a representation of a configuration data for the digital transmitter device;
addressing said message data using said configuration recipient address data, said message data including the representation of the configuration data for the digital transmitter device;
sending said message data over at least one communication network to the configuration recipient address of the configuration recipient address data;
retrieving from the recipient at the configuration recipient address the configuration data for the digital transmitter device using the representation of the configuration data for the digital transmitter device address;
transmitting the configuration data for the digital transmitter device to said digital transmitter device over the at least one communication network;
processing the configuration data with the digital transmitter device to configure the digital transmitter device.

8. The method as defined in claim 7, further comprising:
accepting user input through the user interface of said configured digital transmitter device, said user input including user provided data selected from a group of data comprising email address data, subject data, and text data;
optically scanning at least one object to form corresponding scanned object data;
forming said message data by combining said scanned object data, said email address data and said user provided data; and
addressing said message data using said email address data.

9. The method as recited in claim 8, further comprising:
sending said message data using said email address data over at least one communication network to at least one remote device connected to said communication network and operatively associated with a user address that is included in said email address data.

10. The method as recited in claim 8, wherein said email address data includes a plurality of user email addresses.

11. The method as recited in claim 9, wherein said digital transmitter is included within a multiple function peripheral device, which further includes a printer device that is operatively coupled to said digital transmitter device.

12. The method as recited in claim 11, further comprising:
selectively printing at least one document using said printer device, said at least one document corresponding to said message data.

13. The method as defined in claim 9, further comprising, prior to the accepting user input through a user interface of said digital transmitter device:
editing the configuration data for the digital transmitter device at the configuration recipient address.

14. The method as defined in claim 13, wherein the editing is performed using a remote device connected to the configuration recipient address via said at least one communication network.

15. The method as defined in claim 14, wherein the configuration data for the digital transmitter device at the configuration recipient address is stored in at least one menu page.

16. The method as defined in claim 15, wherein the menu page is a markup language document that is formatted using a markup language selected from the group consisting of Hyper Text Markup Language (HTML) and Extensible Markup Language (XML).

17. The method as defined in claim 13, wherein the editing is performed using a browser application upon the configuration data for the digital transmitter device at the configuration recipient address.

18. The method as defined in claim 18, wherein the editing is performed upon configuration data for other digital transmitter devices in communication with the at least one communication network.

19. A method comprising the steps:
sending message data from an unconfigured digital transmitter device requesting configuration data; and
interpreting the requested configuration information with the unconfigured digital transmitter device to configure the unconfigured digital transmitter device.

20. The method as defined in claim 19, further comprising, after configuring the unconfigured digital transmitter device to be a configured digital transmitter device, and after counting up to a time out value with a timer in the configured digital transmitter:
sending message data from the configured digital transmitter device requesting revised configuration data; and
interpreting the requested revised configuration information with the configured digital transmitter device to revise the configuration of the configured digital transmitter device.

21. A computer usable medium having embodied thereon a computer program for configuring an unconfigured digital transmitter device that is capable of sending message data, the computer program comprising:
a first code segment to receive input at the unconfigured digital transmitter device of a network address at which at configuration information for the unconfigured digital transmitter device is located;
a second code segment to send message data from the unconfigured digital transmitter device to the network address, the message data containing a request for the configuration information;
a third code segment to receive at the unconfigured digital transmitter device the configuration information from the network address; and
a fourth code segment to process the configuration information at the unconfigured digital transmitter device to configure digital transmitter device.

22. The computer program as defined in claim 21, further comprising:
a fifth code segment to receive at the configured digital transmitter device an email address for sending message data;
a sixth code segment to optically scan at the configured digital transmitter device at least one object to form corresponding scanned object data;
a seventh code segment to form in said message data said scanned object data; and
an eight code segment to address said message data using said email address data.

23. The computer program as defined in claim 21, wherein the fourth code segment is to interpret the configuration information contained in at least one menu page.

24. The computer program as defined in claim 23, wherein the menu page is a markup language document formatted using a markup language selected from the group consisting of Hyper Text Markup Language (HTML) and Extensible Markup Language (XML).

25. A computer usable medium having embodied thereon a computer program for configuring a digital transmitter device that is capable of sending message data, the computer program comprising:
a first code segment to receive message data at a network resource located at a network address, the message data being received from an unconfigured digital transmitter device and including the network address and a request for configuration information for the unconfigured digital transmitter device; and
a second code segment to transmit from the network address a markup language document to the unconfigured digital transmitter device, wherein the markup language document:
contains predetermined configuration information sufficient to configure the unconfigured digital transmitter device; and
is formatted in a markup language selected from the group consisting of Hyper Text Markup Language (HTML) and Extensible Markup Language (XML).

26. The computer program as defined in claim 25, further comprising a third code segment, for execution prior to the second code segment, to edit the markup language document using a browser application to create the predetermined configuration information sufficient to configure the unconfigured digital transmitter device.

27. A computer usable medium having embodied thereon a computer program for configuring a digital transmitter device that is capable of sending message data, the computer program comprising:
a first code segment to accept user input through a user interface of said digital transmitter device, said user input including user provided data comprising configuration recipient address data and a representation of a configuration data for the digital transmitter device;
a second code segment to address said message data using said configuration recipient address data, said message data including the representation of the configuration data for the digital transmitter device;
a third code segment to send said message data over at least one communication network to the configuration recipient address of the configuration recipient address data;
a fourth code segment to retrieve from the recipient at the configuration recipient address the configuration data for the digital transmitter device using the representation of the configuration data for the digital transmitter device address;
a fifth code segment to transmit the configuration data for the digital transmitter device to said digital transmitter device over the at least one communication network; and
a sixth code segment to process the configuration data with the digital transmitter device to configure the digital transmitter device.

28. The computer program as defined in claim 27, further comprising:
a seventh code segment to accept additional user input through the user interface of said configured digital transmitter device, said user input including user provided data selected from a group of data comprising email address data, subject data, and text data;
an eight code segment to optically scan at least one object to form corresponding scanned object data;
a ninth code segment to form said message data by combining said scanned object data, said email address data and said user provided data; and
a tenth code segment to address said message data using said email address data.

29. The computer program as defined in claim 28, further comprising an eleventh code segment to send said message data using said email address data over at least one communication network to at least one remote device connected to said communication network and operatively associated with a user address that is included in said email address data.

30. The computer program as defined in claim 28, wherein said email address data includes a plurality of user email addresses.

31. The computer program as defined in claim 29 wherein said digital transmitter is included within a multiple function peripheral device, which further includes a printer device that is operatively coupled to said digital transmitter device.

32. The computer program as defined in claim 31, further comprising a twelfth code segment to selectively print at least one document using said printer device, said at least one document corresponding to said message data.

33. The computer program as defined in claim 29, further comprising a twelfth code segment to edit the configuration data for the digital transmitter device at the configuration recipient address.

34. The computer program as defined in claim 33, wherein the editing is performed using a remote device connected to the configuration recipient address via said at least one communication network.

35. The computer program as defined in claim 34, wherein the configuration data for the digital transmitter device at the configuration recipient address is stored in at least one menu page.

36. The computer program as defined in claim 35, wherein the menu page is a markup language document that is formatted using a markup language selected from the group consisting of Hyper Text Markup Language (HTML) and Extensible Markup Language (XML).

37. The computer program as defined in claim 33, wherein the twelfth code segment is to edit using a browser application upon the configuration data for the digital transmitter device at the configuration recipient address.

38. The computer program as defined in claim 37, wherein the editing is performed upon configuration data for other digital transmitter devices in communication with the at least one communication network.

39. A computer usable medium having embodied thereon a computer program comprising:
a first code segment to send message data from an unconfigured digital transmitter device requesting configuration data; and
a second code segment to interpret the requested configuration information with the unconfigured digital transmitter device to configure the unconfigured digital transmitter device.

40. The computer program as defined in claim 39, further comprising a third code segment for execution after:
the second code segment; and
a counting up to a time out value with a timer in the configured digital transmitter;
wherein the third code segment is executed to:
send message data from the configured digital transmitter device requesting revised configuration data; and
interpret the requested revised configuration information with the configured digital transmitter device to revise the configuration of the configured digital transmitter device.

41. An apparatus capable of sending message data, the apparatus comprising:
a scanning mechanism configurable to optically scan at least one object to form corresponding scanned object data;
an input device for receiving configuration data including configuration recipient address data and a representation of a configuration data for the digital transmitter device;
logic operatively coupled to said input device, said logic being configured to form message data with said configuration recipient address data, and wherein said message data is configured to at least be sent to said at least one address associated with said intended message data recipient;
at least one network interface operatively coupled to said logic and configurable to:
send said message data to said intended message data recipient over at least one communication network; and
receive the configuration data for the digital transmitter device from said intended message data recipient over the at least one communication network configure;
a module associated with said logic for processing the configuration data to configure the digital transmitter device.

42. The apparatus as recited in claim 41, further comprising:
a scanning mechanism configurable to optically scan at least one object to form corresponding scanned object data;
a module in the input device operatively coupled to said logic and configured to accept user input, said user input including user provided data selected from a group of data comprising address data, subject data, and text data; and
wherein said logic is further configured to form said message data by combining said scanned object data, said recipient address data and said user provided data.

43. The apparatus as recited in claim 42, wherein said user input including user provided data address further comprises additional mail data and includes a plurality of addresses associated with a plurality of intended message data recipients.

44. The apparatus as recited in claim 42, further comprising:
memory that is operatively coupled to said logic, and
wherein said logic is further configured to maintain at least one recipient address data list within said memory, said recipient address data list comprising a plurality of addresses associated with a plurality of potential message data recipients.

45. The apparatus as recited in claim 42, wherein:
said apparatus is included within a multiple function peripheral device;
said multiple function peripheral device further includes a printer device that is operatively coupled to said logic; and
said logic is further configured to cause said printer device to selectively print at least one document corresponding to said message data.

46. The apparatus as recited in claim 41, wherein the module associated with said logic for processing the configuration data to configure the digital transmitter device is configured to process at least one menu page.

47. The apparatus as recited in claim 46, wherein the menu page is a markup language document that is formatted using a markup language selected from the group consisting of Hyper Text Markup Language (HTML) and Extensible Markup Language (XML).

48. A digital transmitter device comprising:
means for transmitting message data to a network address from the digital transmitter device, wherein the digital transmitter device is in an unconfigured state thereof, and the message data includes a request for configuration information for the unconfigured digital transmitter; and
means, at the digital transmitter device in the unconfigured state, for processing the requested configuration information after receipt of same from the network address, whereby the digital transmitter device in the unconfigured state configures the unconfigured digital transmitter device into a configured state.

49. The digital transmitter device as defined in claim 48, wherein the means for processing the requested configuration information further comprises means for deriving the requested configuration information from a markup language document formatted using a markup language selected from the group consisting of Hyper Text Markup Language (HTML) and Extensible Markup Language (XML).

50. The digital transmitter device as defined in claim 48, in the configured state thereof, further comprising:
means for receiving input of an email address;
means for optically scanning at least one object to form corresponding scanned object data; and
means for transmitting message data including said scanned object data to the email address.

51. A system comprising:
a communication network
a master digital transmitter device, having a network address on the communication network, for transmitting configuration data over the communication network in response to a request;
a plurality of slave digital transmitter devices in communication with the master digital transmitter device through the communication network, each said slave digital transmitter device including:
a timer for counting a time out value to expiration;
logic configured to form message data upon said expiration, wherein said message data is addressed to the network address of the master digital transmitter device and includes a request for configuration data;
an interface to the communication network and operatively coupled to said logic and configurable to:
transmit the message data to the network address of the master digital transmitter device over the communication network; and
receive the configuration data from the master digital transmitter device over the communication network;
a module associated with said logic for processing the configuration data received from the master digital transmitter device to configure the slave digital transmitter device.
